(19) United States
(12) Patent Application Publication
(10) Pub. No.: US 2024/0305144 A1
(43) Pub. Date: Sep. 12, 2024

(54) METHOD AND APPARATUS FOR PERFORMING POSITION ESTIMATION OF MULTIPLE RECEIVING COIL AND WIRELESS POWER TRANSMISSION

(71) Applicant: ELECTRONICS AND TELECOMMUNICATIONS RESEARCH INSTITUTE, Daejeon (KR)

(72) Inventors: Sang Won KIM, Daejeon (KR); In Kui Cho, Daejeon (KR); Yong Bae Park, Seoul (KR); Jun Heo, Suwon-si (KR)

(21) Appl. No.: 18/511,205

(22) Filed: Nov. 16, 2023

(30) Foreign Application Priority Data
Mar. 7, 2023 (KR) 10-2023-0030155
Apr. 28, 2023 (KR) 10-2023-0056188

(51) Int. Cl. H02J 50/90; G01D 5/20; H01F 38/14; H02J 50/10; H02J 50/40

(52) U.S. Cl. CPC H02J 50/90; G01D 5/204; H01F 38/14; H02J 50/10; H02J 50/40

(57) ABSTRACT

The present invention relates to a method and apparatus for performing position estimation of multiple receiving coil and wireless power transmission. A method for performing wireless power transmission according to an embodiment of the present disclosure may comprise: calculating a current value flowing through one or more transmitting (Tx) coils by measuring an impedance value of the one or more Tx coils; identifying whether a receiving (Rx) coil associated with the one or more Tx coils exists; when one or more Rx coils exist, calculating a correlation value between a Tx coil and a Rx coil for each of the one or more Rx coils; determining a position of the one or more Rx coils; and performing wireless power transmission to the one or more Rx coils.

### CROSS-REFERENCE TO RELATED APPLICATIONS

This application claims the benefit of earlier filing date and right of priority to Korean Application No. 10-2023-0030155, filed on Mar. 7, 2023 and Korean Application No. 10-2023-0056188, filed on Apr. 28, 2023, the contents of which are all hereby incorporated by reference herein in their entirety.

### TECHNICAL FIELD

The present disclosure relates to a method and apparatus for performing position estimation of multiple receiving coil and wireless power transmission.

### BACKGROUND

Wireless power transmission technology and wireless charging technology are actively used in small Internet of Things (IoT) devices such as low-power mobile phones and smart watches of less than 15 W.

Recently, the number of devices that use batteries in daily life is increasing, and accordingly, it may be necessary to charge multiple devices at the same time. In order to charge multiple receiving devices simultaneously, a method is needed to determine the relationship between the transmitting coil and each receiving coil or the position of the receiving coil, and to control the transmitted power according to the relationship.

In the case of the existing method, calculation of mutual inductance through actual measurement or electro-magnetic (EM) simulation is required to determine the relationship between coils. Mutual inductance is a value that must be known in order to determine the position of the coil, calculate transmission power and reception power, and control the transmission coil.

However, in order to calculate mutual inductance through measurement, additional hardware needs to be installed at the transmitter and receiver, and because information must be exchanged through mutual communication, the complexity and cost of the system may increase. Additionally, if the position of the receiving coil is not fixed and is located at a random location, it may be difficult to determine the mutual inductance using measurement and simulation.

### SUMMARY

The technical object of the present disclosure is to provide a method and apparatus for performing position estimation of multiple receiving coil and wireless power transmission.

Specifically, the technical object of the present disclosure is to provide a method and apparatus for determining the position of a coil at an arbitrary location using only the transmitting coil without communication between the transmitter and the receiver, and controlling the transmitting coil to transfer power to the receiving coil.

The technical objects to be achieved by the present disclosure are not limited to the above-described technical objects, and other technical objects which are not described herein will be clearly understood by those skilled in the pertinent art from the following description.

A method for performing wireless power transmission according to an aspect of the present disclosure may comprise: calculating a current value flowing through one or more transmitting (Tx) coils by measuring an impedance value of the one or more Tx coils; identifying whether a receiving (Rx) coil associated with the one or more Tx coils exists, based on a change in the current value; when one or more Rx coils exist, calculating a correlation value between a Tx coil and a Rx coil for each of the one or more Rx coils, based on a voltage and a current applied to the one or more Tx coils; determining a position of the one or more Rx coils, based on the correlation value; and performing wireless power transmission to the one or more Rx coils, based on the determined position.

An apparatus for performing wireless power transmission according to an additional aspect of the present disclosure may comprise a processor and a memory, and the processor may be configured to: calculate a current value flowing through one or more transmitting (Tx) coils by measuring an impedance value of the one or more Tx coils; identify whether a receiving (Rx) coil associated with the one or more Tx coils exists, based on a change in the current value; when one or more Rx coils exist, calculate a correlation value between a Tx coil and a Rx coil for each of the one or more Rx coils, based on a voltage and a current applied to the one or more Tx coils; determine a position of the one or more Rx coils, based on the correlation value; and perform wireless power transmission to the one or more Rx coils, based on the determined position.

As one or more non-transitory computer readable medium storing one or more instructions, the one or more instructions are executed by one or more processors and control an apparatus for performing wireless power transmission according to an additional aspect of the present disclosure to: calculate a current value flowing through one or more transmitting (Tx) coils by measuring an impedance value of the one or more Tx coils; identify whether a receiving (Rx) coil associated with the one or more Tx coils exists, based on a change in the current value; when one or more Rx coils exist, calculate a correlation value between a Tx coil and a Rx coil for each of the one or more Rx coils, based on a voltage and a current applied to the one or more Tx coils; determine a position of the one or more Rx coils, based on the correlation value; and perform wireless power transmission to the one or more Rx coils, based on the determined position.

In various aspects of the present disclosure, the correlation value may be calculated through a matrix calculated using a voltage vector and a current vector for each of the one or more Tx coils and the impedance value.

In this regards, the position of the one or more Rx coils may be determined based on a position of the Tx coil corresponding to a component having a magnitude greater than a pre-defined value in the eigenvector corresponding to the largest eigenvalue of the correlation value.

Additionally, in various aspects of the present disclosure, when a first Rx coil and a second Rx coil exist, the correlation value for the second Rx coil may be calculated by subtracting a correlation value calculated for the first Rx coil from a correlation value calculated for both the first Rx coil and the second Rx coil.

Additionally, in various aspects of the present disclosure, a change of the current value may be determined based on a current value calculated based on a voltage applied to the one or more Tx coils and the impedance value when a Rx coil is absent.

Additionally, in various aspects of the present disclosure, a length of the eigenvector corresponding to the largest eigenvalue of the correlation value may be equal to the number of the one or more Tx coils.

In this regards, each component of the eigenvector may be mapped one-to-one with the one or more Tx coils. Additionally, the wireless power transmission may be performed by a Tx coil corresponding to a component in the eigenvector having a value greater than a pre-defined value.

Additionally, in various aspects of the present disclosure, a check for whether a receiving (Rx) coil associated with the one or more Tx coils exists may be continuously performed according to a pre-configured period.

According to the present disclosure, a method and apparatus for determining the positions of multiple receiving coils and performing wireless power transmission may be provided.

According to the present disclosure, a method and apparatus for determining the position of a coil at an arbitrary location using only the transmitting coil without communication between the transmitter and the receiver, and controlling the transmitting coil to transfer power to the receiving coil may be provided.

According to the present disclosure, by detecting the current of the transmitting coil that changes in real time, it is possible to determine the presence of an additional receiving coil and respond by repeating the same operation.

According to the present disclosure, system efficiency may be increased by using only the transmitting coil that overlaps the receiving coil without operating unnecessary transmitting coils.

Effects achievable by the present disclosure are not limited to the above-described effects, and other effects which are not described herein may be clearly understood by those skilled in the pertinent art from the following description.

### BRIEF DESCRIPTION OF THE DRAWINGS

FIG. 1 illustrates an operational flowchart of a method for performing wireless power transmission to multiple receiving coils according to an embodiment of the present disclosure.

FIG. 2 illustrates the arrangement of a transmitting coil and a receiving coil according to an embodiment of the present disclosure.

FIGS. 3A and 3B illustrate a current measurement result of a transmitting coil depending on the presence or absence of a receiving coil according to an embodiment of the present disclosure.

FIG. 4 illustrates the result of determining the position of a receiving coil according to an embodiment of the present disclosure.

FIG. 5 illustrates various receiving coil arrangements according to an embodiment of the present disclosure.

FIGS. 6A, 6B, 7A, and 7B illustrate mutual inductance and eigenvector analysis results in various receiving coil arrangements according to an embodiment of the present disclosure.

FIG. 8 illustrates an operation flowchart of determining a receiving coil position and controlling a transmitting coil for power transmission according to an embodiment of the present disclosure.

FIG. 9 is a block diagram illustrating a device according to an embodiment of the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

The existing receiving coil position estimation method requires adding a coil to the transmitter solely for the purpose of detecting the position of the receiving (Rx) coil, or using an additional sensor. Additionally, additional hardware for communication may also be required. Accordingly, the method is limited in its use in situations where there is no communication between the transmitter and receiver, and the overall cost and complexity of the system increases, and efficiency is reduced.

Therefore, even in an environment where there is no communication process between the transmitter and receiver, a transmitting (Tx) coil control method for determining the position of the Rx coil and Tx power without additional hardware needs to be considered.

In consideration of the above-mentioned points, the present disclosure proposes a method for determining the positions of multiple Rx coils and performing wireless power transmission in an environment where there is no communication between the Tx coil and the Rx coil.

Specifically, hereinafter, with regard to wireless power transmission and wireless charging in an environment without communication between the Tx coil and the Rx coil, the present disclosure proposes a method of determining the positions of multiple Rx coils using only the Tx coil, and a method of controlling the Tx coil to transmit power to the Rx coil based on this.

Communication between the Tx coil and the Rx coil described in the present disclosure may mean communication between a Tx device (i.e., a device that transmits wireless power) equipped with a Tx coil and a Rx device (i.e., a device that receives wireless power) equipped with a Rx coil.

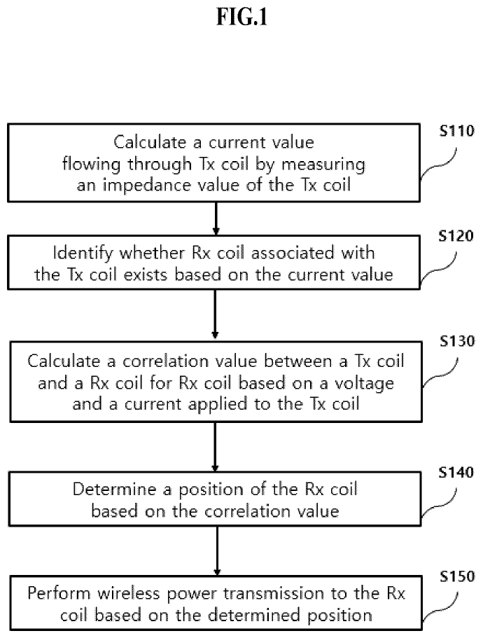

FIG. 1 illustrates an operational flowchart of a method for performing wireless power transmission to multiple receiving coils according to an embodiment of the present disclosure.

In step S110, an impedance value of one or more Tx coils may be measured to calculate the current value flowing through the one or more Tx coils.

In this case, the corresponding impedance value may be measured based on the relationship between the voltage applied to the corresponding Tx coil and the current measured accordingly when the Rx coil does not exist.

Using the corresponding impedance value, the current value expected to flow when the measurement voltage is applied to the corresponding Tx coil may be predicted/calculated.

In step S120, the presence or absence of a Rx coil associated with the one or more Tx coils may be confirmed/identified based on a change in the current value flowing through the Tx coil.

For example, the change in the current value may be determined based on a current value calculated based on the voltage applied to the one or more Tx coils and the impedance when there is no Rx coil.

In this regard, confirmation/check of the presence or absence of a Rx coil associated with the one or more Tx coils may be continuously performed according to a pre-configured period. For example, as the period is set to a short time, an operation to check the existence of the Rx coil may be performed in real time.

In step S130, when one or more Rx coils exist, a correlation value between the Tx coil and the Rx coil may be calculated for each of the one or more Rx coils, based on the voltage and current applied to the one or more Tx coils.

For example, the correlation value between the Tx coil and the Rx coil may be related to a value that plays a similar role as the mutual inductance between the Tx coil and the Rx coil.

For example, the correlation value may be calculated through a matrix calculated using the impedance value and the voltage vector and current vector for each of the one or more Tx coils. As a specific example, the correlation value may be calculated by taking only the real part of the matrix.

For example, when a first Rx coil and a second Rx coil exist (i.e., when two or more Rx coils exist), the correlation value for the second Rx coil may be calculated by subtracting the correlation value calculated for the first Rx coil from the correlation value calculated for both the first Rx coil and the second Rx coil.

In step S140, the position of the one or more Rx coils may be determined based on the correlation value described above.

For example, the position of the one or more Rx coils may be determined based on the position of the Tx coil corresponding to a component having a size greater than a pre-defined value in the eigenvevtor corresponding to the largest eigenvalue of the aforementioned correlation values.

In step S150, wireless power transmission may be performed to the one or more Rx coils based on the determined positions of the Rx coils.

In this regard, the length of the eigenvector corresponding to the largest eigenvalue of the above-described correlation value may be equal to the number of the one or more Tx coils, and at this time, each component of the corresponding eigenvector may be one-to-one mapped with the one or more Tx coils. In this case, the wireless power transmission described above may be performed by a Tx coil corresponding to a component in the eigenvector having a value greater than a pre-defined value.

Based on the above-described procedure, the presence and location of the Rx coil may be determined only with information about the Tx coil, without communication between the Tx device and the Rx device. Additionally, based on this, wireless power transmission may be performed by operating only the Tx coil associated with the corresponding Rx coil, making it efficient in terms of system operation.

Referring to the descriptions of FIG. 1 described above, hereinafter, in the present disclosure, without communication between the Tx coil and the Rx coil, a detailed method of determining the position/existence of multiple Rx coils and controlling the Tx coil based on this to transmit power to the receiving coil will be explained.

In relation to determining the position of the Rx coil, it is necessary to first confirm/identify/check whether the Rx coil exists.

In an environment where there is no communication between a transmitter and a receiver, a method of determining whether a Rx coil exists using only a Tx coil may be necessary.

For example, when a arbitrary voltage (\vec{v}) is applied to n Tx coils in a situation where there is no Rx coil, the Tx coil current (\vec{l}_{T})) based on the voltage-current relationship expressed in Equation 1 below may flow.

Equation 1 illustrates the relationship between the voltage applied to the Tx coil and the flowing current when the Rx coil does not exist.

$${\vec{i}}_{T} = [ \begin{matrix}{I}_{T 1} \\ ⋮ \\ {I}_{Tn}\end{matrix} ] = {[ \begin{matrix}{Z}_{T 1} & j ω {M}_{T 12} & … & j ω {M}_{T 1 n} \\ j ω {M}_{T 21} & {Z}_{T 2} & … & j ω {M}_{T 2 n} \\ ⋮ & ⋮ & ⋱ & ⋮ \\ j ω {M}_{Tn 1} & j ω {M}_{Tn 2} & … & {Z}_{Tn}\end{matrix} ]}^{- 1} [ \begin{matrix}{V}_{T 1} \\ ⋮ \\ {V}_{Tn}\end{matrix} ] = {Z}_{T}^{- 1} {\vec{v}}_{T} \qquad [ Equation 1 ]$$

In Equation 1, Z_{Tn} represents the impedance of the n^{th}Tx coil, V_{Tn} represents the voltage of the n^{th} Tx coil, and I_{Tn} represents the current of the n^{th} Tx coil. Additionally, M_{Tij} represents the mutual inductance between the i^{th} Tx coil and the j^{th} Tx coil.

By calculating the impedance matrix of the Tx coil with reference to Equation 1, the value of the current flowing when an arbitrary voltage is applied may be predicted. If the Rx coil is not present, the current will continue to flow at the expected value.

In contrast, when a Rx coil to receive power is added, the relationship between the voltage applied to the Tx coil and the current flowing may be changed as shown in Equation 2 below.

Equation 2 illustrates the relationship between the voltage applied to the Tx coil and the flowing current when the Rx coil exists.

$${\vec{i}}_{T} = [ \begin{matrix}{I}_{T 1} \\ ⋮ \\ {I}_{Tn}\end{matrix} ] = {\{ [ \begin{matrix}{Z}_{T 1} & j ω {M}_{T 12} & … & j ω {M}_{T 1 n} \\ j ω {M}_{T 21} & {Z}_{T 2} & … & j ω {M}_{T 2 n} \\ ⋮ & ⋮ & ⋱ & ⋮ \\ j ω {M}_{Tn 1} & j ω {M}_{Tn 2} & … & {Z}_{Tn}\end{matrix} ] + Ψ \}}^{- 1} [ \begin{matrix}{V}_{T 1} \\ ⋮ \\ {V}_{Tn}\end{matrix} ] \qquad [ Equation 2 ]$$

$$\begin{matrix}Ψ = {{{ω}^{2} [ \begin{matrix}{M}_{11} & {M}_{21} & … & {M}_{n 1} \\ ⋮ & ⋮ & ⋱ & ⋮ \\ {M}_{1 k} & {M}_{2 k} & … & {M}_{nk}\end{matrix} ]}^{T} [ \begin{matrix}{Z}_{R 1} & j ω {M}_{R 12} & … & j ω {M}_{R 1 k} \\ j ω {M}_{R 21} & {Z}_{R 2} & … & j ω {M}_{R 2 k} \\ ⋮ & ⋮ & ⋱ & ⋮ \\ j ω {M}_{Rk 1} & j ω {M}_{Rk 2} & … & {Z}_{Rk}\end{matrix} ]}^{- 1} \\ [ \begin{matrix}{M}_{11} & {M}_{21} & … & {M}_{n 1} \\ ⋮ & ⋮ & ⋱ & ⋮ \\ {M}_{1 k} & {M}_{2 k} & … & {M}_{nk}\end{matrix} ] \\ = {ω}^{2} {M}^{T} {Z}_{R}^{- 1} M\end{matrix}$$

In Equation 2, ω represents the resonant frequency, Z_{Rk} represents the impedance of the k^{th} Rx coil, and Mₙₖ represents the mutual inductance between the n^{th} Tx coil and the k^{th} Rx coil.

In other words, the current (\vec{i}_{T}) flowing due to a arbitrary voltage (\vec{v}_{T}) when the Rx coil does not exist changes in value when the Rx coil exists.

The change in current value as described above may be confirmed through the results of Tx coil current measurement according to the arrangement of the Tx coil and Rx coil as follows.

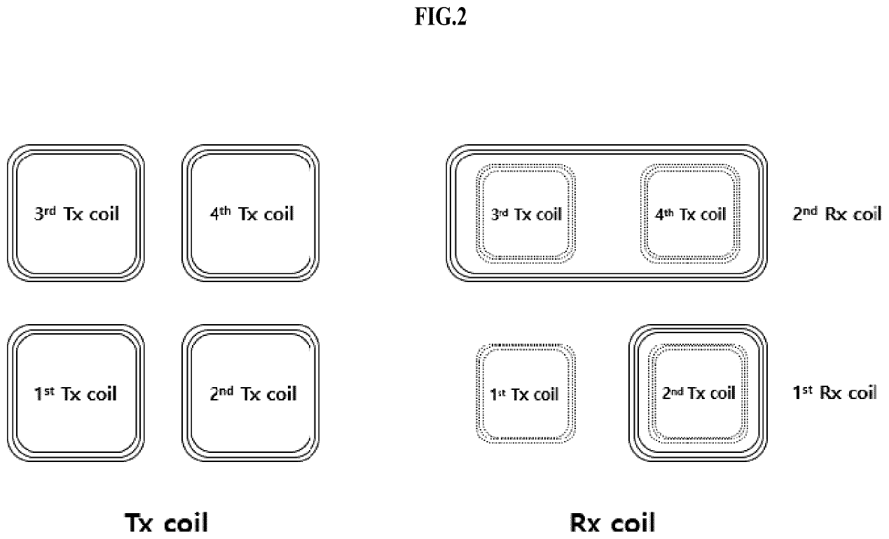

FIG. 2 illustrates the arrangement of a transmitting coil and a receiving coil according to an embodiment of the present disclosure.

Referring to FIG. 2, in a state where four Tx coils (i.e., a first Tx coil, a second Tx coil, a third Tx coil, and a fourth Tx coil) are arranged, a change in current flowing through the Tx coil depending on the presence of the Rx coil may be measured.

For example, the first Rx coil may be disposed above the second Tx coil, and the second Rx coil may be disposed above the third and fourth Tx coils.

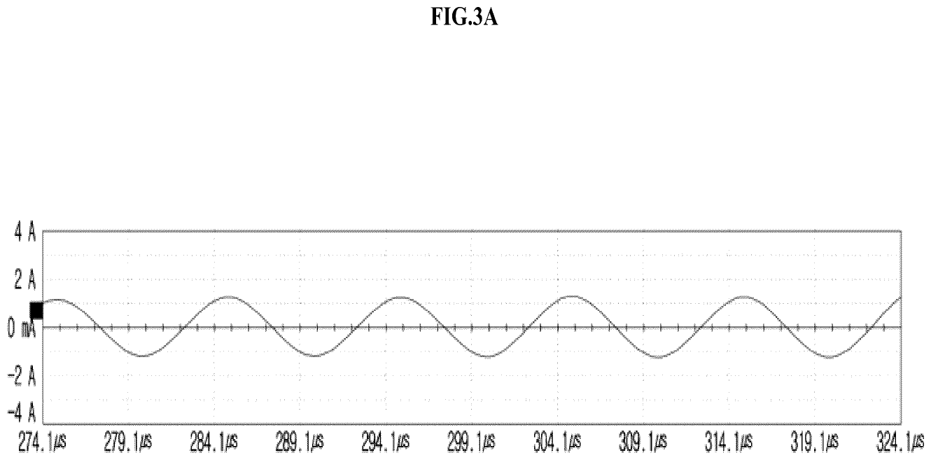

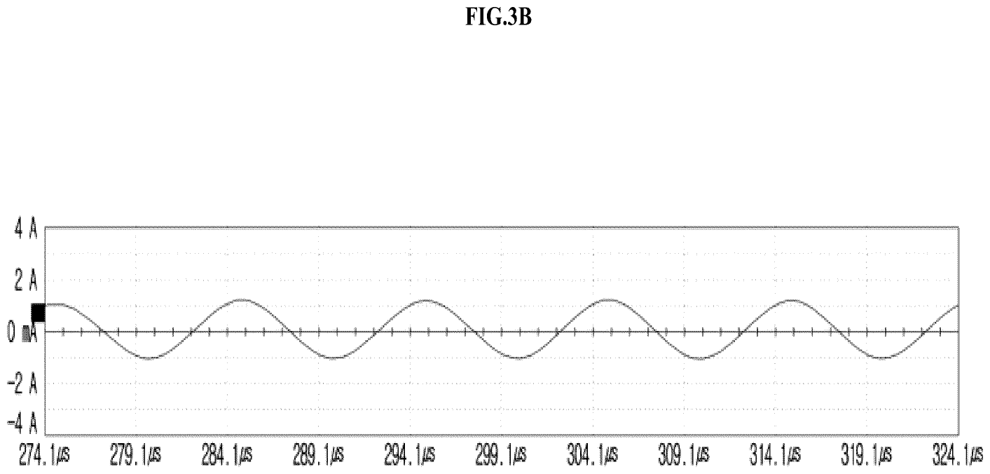

When the first Rx coil may be disposed above the second Tx coil, the change in current flowing through the Tx coil may be as shown in FIG. 3.

FIG. 3 illustrates a current measurement result of a transmitting coil depending on the presence or absence of a receiving coil according to an embodiment of the present disclosure.

FIG. 3A illustrates the result of measuring the current flowing in the Tx coil when the Rx coil does not exist. On the other hand, FIG. 3B illustrates the result of measuring the current flowing in the Tx coil when the Rx coil is present.

Referring to FIGS. 3A and 3A, compared to the case where the Rx coil exists, the current flowing in the Tx coil changes when the Rx coil is present.

Accordingly, the presence of a Rx coil may be determined by checking whether a change in the current flowing through the Tx coil occurs.

In this regard, the process continues throughout the entire process, and whether or not a Rx coil has been added, that is, whether it exists, may be confirmed in real time.

Next, a method for determining the position of the Rx coil will be described.

Determining the position of the Rx coil is similar to determining how much influence it may have on the Rx coil when voltage is applied to the Tx coil. That is, if a Tx coil may have a significant influence on a Rx coil, the Rx coil may be determined to exist near the Tx coil.

In this regard, the degree of influence between coils may be confirmed through mutual inductance.

Equation 3 illustrates the relationship between the current flowing through the Tx coil and the Rx coil and the mutual inductance.

$${\vec{i}}_{R} = j ω {Z}_{R}^{- 1} M {\vec{i}}_{T} \qquad [ Equation 3 ]$$

In Equation 3, \vec{l}_{T} represents the vector of current flowing in the Tx coil, \vec{l}_{R} represents the vector of current flowing in the Rx coil, M represents the mutual inductance, and Z_{R} represents the impedance of the Rx coil.

At this time, if the current value flowing in the Rx coil and the impedance of the Rx coil are unknown, a value that may be used instead of the mutual inductance may be needed.

The present disclosure proposes a method for calculating/obtaining a value that may be used in place of mutual inductance, that is, playing a similar role to mutual inductance.

Specifically, by applying arbitrary independent voltage vectors equal to the number n of Tx coils to the Tx coils whose positions are fixed and measuring the current flowing in the Tx coil, the corresponding value may be calculated/obtained based on Equation 4 below.

Equation 4 illustrates an equation for calculating a value that plays a similar role as mutual inductance.

$$Ψ = {[ {\vec{v}}_{T}^{( 1 )} , … , {\vec{v}}_{T}^{( n )} ] [ {\vec{i}}_{T}^{( 1 )} , … , {\vec{i}}_{T}^{( n )} ]}^{- 1} - {Z}_{T} \qquad [ Equation 4 ]$$

In Equation 4, \vec{v}_{T}⁽ⁿ⁾ represents the n^{th} voltage vector applied to the Tx coil, and \vec{i}_{T}⁽ⁿ⁾ represents the nth current vector flowing in the Tx coil.

At this time, the matrix [symbol] (Ψ), which may be obtained by taking only the real part of the calculated Ψ, may have a value proportional to the matrix M^{T}M. Here, the eigenvector corresponding to the largest eigenvalue has the characteristic of being proportional to the mutual inductance between the Tx coil and the Rx coil.

In other words, by calculating [symbol] (Ψ) according to Equation 4 using only the Tx coil and analyzing the eigenvector of the largest eigenvalue, the size ratio of the mutual inductance between the Rx coil and the Tx coil may be obtained/confirmed.

If multiple Rx coils (i.e., two or more Rx coils) are considered, [symbol] (Ψ) may not be proportional to M^{T}M, but may be proportional to M^{T}R_{R}M. Since R_{R} is a diagonal matrix whose components are the internal resistance of the Rx coil, if the internal resistances of the Rx coils are not all the same, the ratio of the eigenvectors may not be the same as the ratio of the mutual inductances.

Therefore, for multiple Rx coils, a different method needs to be used to determine the position of the Rx coils.

When multiple Rx coils exist and each Rx coil is arranged in parallel, ω²M_{Rij}²≈0 may be assumed. Here, a represents the resonant frequency, and M_{Rij} represents the mutual inductance between the i^{th} Rx coil and the j^{th} Rx coil.

If the calculation according to Equation 4 is performed for all Rx coils and the result of calculating the real part is referred to as [symbol] (Total), the following Equation 5 may be established.

Equation 5 illustrates the definition of [symbol] (Ψ)^{(Total)} for multiple Rx coils.

$${( Ψ )}^{( Total )} = {\sum }_{i} {( Ψ )}^{( Rx i )} \qquad [ Equation 5 ]$$

In reality, unless multiple Rx coils overlap or face each other, the mutual inductance value between Rx coils may correspond to a negligible value. Additionally, multiple Rx coils may not appear in the charging area at exactly the same moment.

Therefore, if [symbol] (Ψ)^{(Rx i)} corresponding to the previously entered/existing Rx coil has already been recognized, [symbol] (Ψ)^{(Rx i)} corresponding to each Rx coil can be calculated using Equation 5 described above. Thereafter, the positions of all Rx coils may be determined/confirmed by analyzing the eigenvalue and eigenvector of [symbol] (Ψ)^{(Rx i)}.

Once the position of each Rx coil is determined through the above-described method, a Tx coil optimized for Tx power to the corresponding Rx coil may be determined.

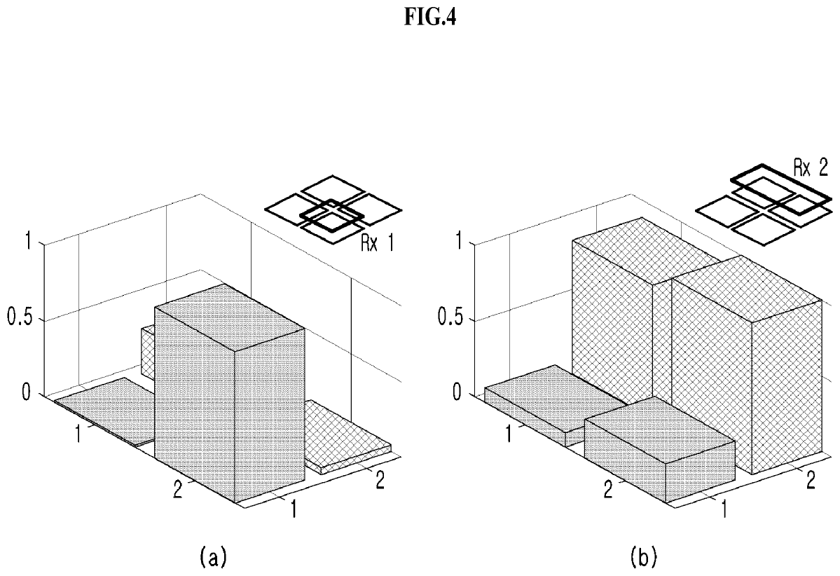

FIG. 4 illustrates the result of determining the position of a receiving coil according to an embodiment of the present disclosure.

Referring to FIG. 4, position determination of the first Rx coil and the second Rx coil may be performed with respect to the Tx coil arranged as in FIG. 2.

That is, it is assumed that the first Rx coil exists above the second Tx coil, and the second Rx coil exists above the third Tx coil and the fourth Tx coil.

FIG. 4A illustrates the results of calculating [symbol] (Ψ)^{(Rx 1)} when the first Rx coil exists and analyzing the size of the eigenvector for this. Additionally, FIG. 4B illustrates the results of calculating [symbol] (Ψ)^{(Rx 2)} when the second Rx coil exists and analyzing the size of the eigenvector for this.

For example, referring to the method in the case where there are a plurality of Rx coils described above, [symbol] (Ψ)^{(Rx 2)} when the second Rx coil is present may be calculated by subtracting [symbol] (Ψ)^{(Rx 1)} when the first Rx coil exists from [symbol] (Ψ)^{(Total)} when the first and second Rx coils exist. This may be effective in the case where the first Rx coil exists before/before the second Rx coil.

Referring to FIGS. 4A and 4B, it may be seen that the value of the eigenvector is larger in the Tx coil at the same or close to the position of the Rx coil.

The method proposed in the present disclosure may be applied not only to the arrangement of the Tx coil and the Rx coil as illustrated in FIG. 2, but also to various arrangement forms.

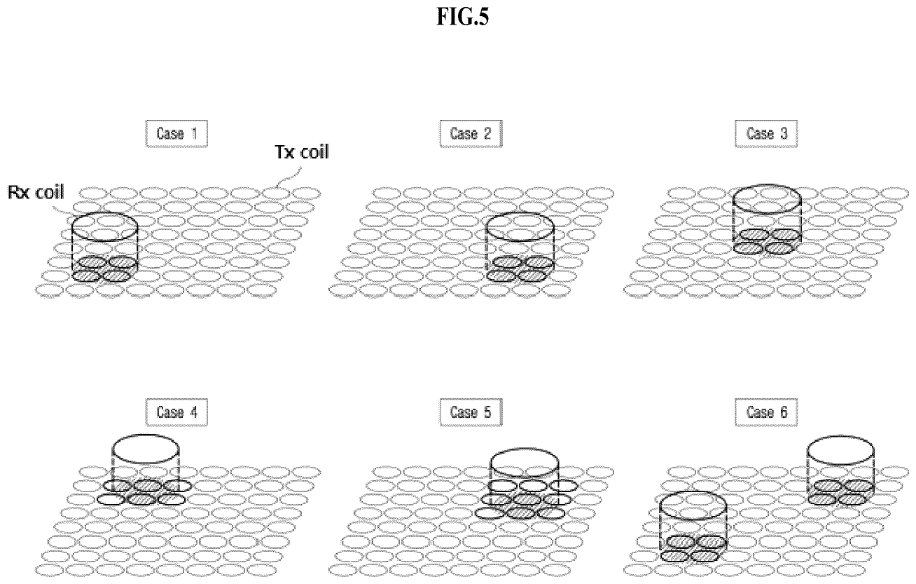

FIG. 5 illustrates various receiving coil arrangements according to an embodiment of the present disclosure.

Referring to FIG. 5, 64 Tx coils are arranged, and the area overlapping with the Tx coil may vary depending on the position of one or more Rx coils.

Here, the Tx coil corresponding to the overlapping portion of the Rx coil and the Tx coil may correspond to a Tx coil suitable for transmitting power to the corresponding Rx coil.

For example, the area for one Rx coil may be associated with/overlap with the area for four Tx coils. As a specific example, various cases may be considered by changing the position of the Rx coil, such as Case 1 to Case 3.

Additionally or alternatively, the area for one Rx coil may be associated with/overlapping with the area for six Tx coils, such as Case 4, or the area for nine Tx coils, such as Case 5, depending on position.

Additionally or alternatively, as in Case 6, the areas for the two Rx coils may be associated/overlapping with the areas for the eight Tx coils.

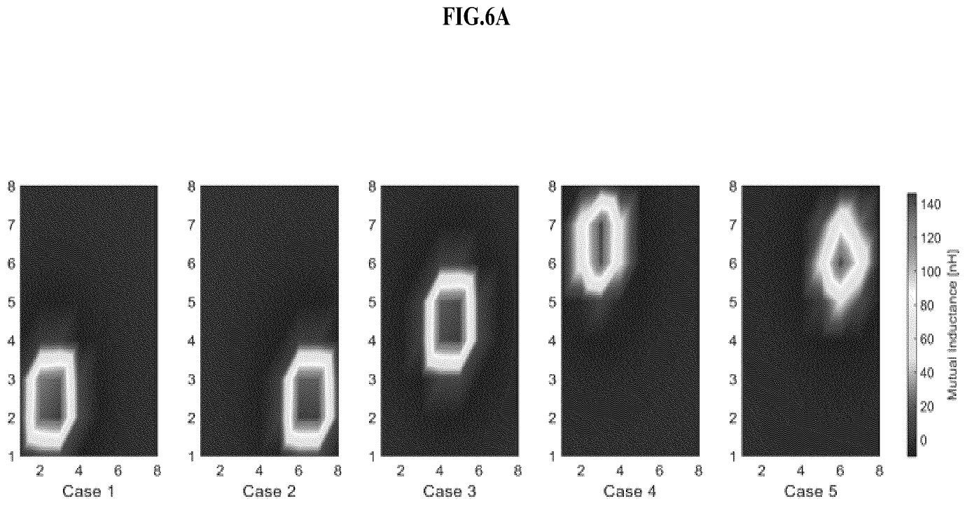

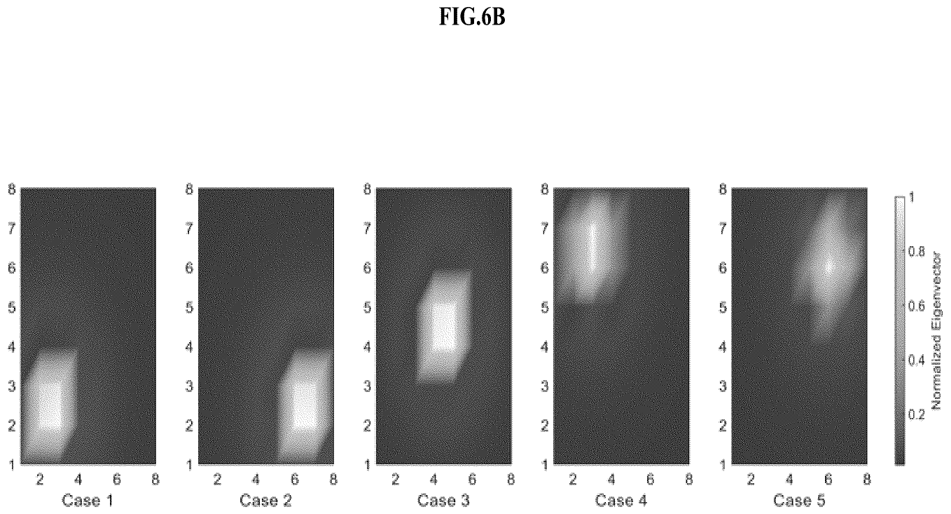

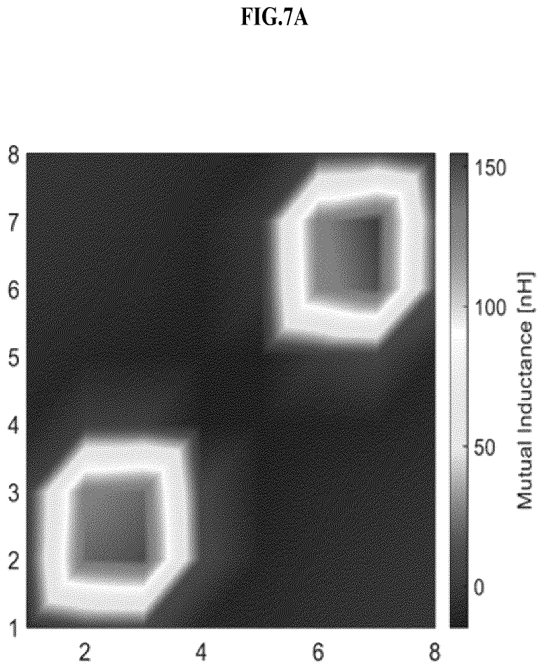

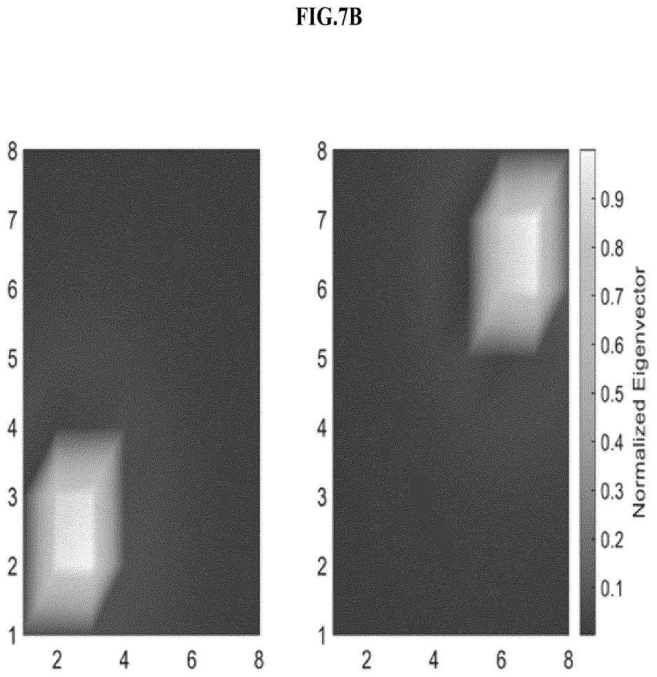

FIGS. 6 and 7 illustrate mutual inductance and eigenvector analysis results in various receiving coil arrangements according to an embodiment of the present disclosure.

FIG. 6A illustrates simulation results for mutual inductance in Case 1 to Case 5 of FIG. 5, and FIG. 6B illustrates the results of analyzing the eigenvector values proposed in the present disclosure in Cases 1 to 5 of FIG. 5.

Additionally, FIG. 7A illustrates simulation results for mutual inductance in Case 6 of FIG. 5, and FIG. 7B illustrates the results of analyzing the eigenvector values proposed in the present disclosure in Case 6 of FIG. 5.

Referring to FIGS. 6 and 7, the mutual inductance and the eigenvector value proposed in the present disclosure have similar forms in terms of determining the position of the Rx coil.

In conclusion, even when the mutual inductance value is unknown, the position of the Rx coil may be determined through analysis of the eigenvector according to the method proposed in the present disclosure. That is, according to the method proposed in the present disclosure, the location and presence of one or more Rx coils may be confirmed/determined only with information on the Tx coil.

By analyzing, [symbol] (Ψ)^{(Rx i)} calculated based on Equation 5 above and calculating the eigenvector corresponding to the largest eigenvalue, the corresponding eigenvector may have a length equal to the number of Tx coils. Here, each component of the corresponding eigenvector may have a one-to-one correspondence with each Tx coil.

When the number of transmitting coils is sufficiently large, power may be transmitted by operating a different Tx coil for each of one or more Rx coils.

In other words, different Tx coils may be operated using the sum of the eigenvectors for all Rx coils obtained through analysis of [symbol] (Ψ)^{(Rx i)}, and, through this, it may be possible to control received(/transmitted) power.

For example, under the condition that ω²M_{Rij}²≈0, the power (P_{R}) transmitted to the Rx coil may be equal to Equation 6.

Equation 6 illustrates the formula for the sum of received power for all Rx coils.

$${P}_{R} = {\vec{i}}_{R}^{H} {R}_{R} {\vec{i}}_{R} = {\vec{i}}_{T}^{H} {H}^{H} {R}_{R} {H}^{( Total )} {\vec{i}}_{T} \qquad [ Equation 6 ]$$

Additionally, the current (\vec{l}_{T}) for controlling the Tx coil to suit the desired received power may be expressed as Equation 7.

Equation 7 illustrates the current formula for controlling the Tx coil.

$${\vec{i}}_{T} = {[ {c}_{1} \cdot {i}_{T 1} , … , {c}_{n} \cdot {i}_{Tn} ]}^{T} \\ {i}_{Ti} = \{ \begin{matrix}0 , & no Rx coil on i - th Tx coil \\ \begin{matrix}i - th row of \\ max eig ( {ℜ ( Ψ )}^{( Rx j )} )\end{matrix} , & j - th Rx coil on i - th Tx coil\end{matrix} \qquad [ Equation 7 ]$$

In equation 7, c represents a constant that controls the scale of the current, and maxeig represents the eigenvector corresponding to the largest eigenvalue.

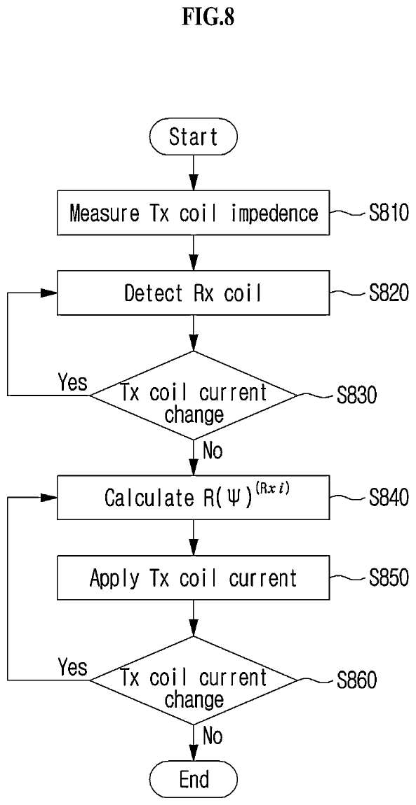

FIG. 8 illustrates an operation flowchart of determining a Rx coil position and controlling a Tx coil for power transmission according to an embodiment of the present disclosure.

Referring to FIG. 8, in step S810, the Tx coil impedance may be measured.

For example, if the impedance matrix of the Tx coil is calculated, the value of the current flowing when a certain voltage is applied to the Tx coil may be predicted/calculated.

In step S820, Rx coil detection may be performed.

For example, based on measured/calculated Tx coil impedance, the current in the Tx coil depending on the presence or absence of the Rx coil can be determined/confirmed using Equation 1 and/or Equation 2 described above. Rx coil detection may be performed based on the current in the Tx coil determined/confirmed in this way.

Specifically, in step S830, it may be determined whether the current of the Tx coil changes.

If there is no change in the current of the Tx coil, the detection procedure for the Rx coil may be continuously performed. That is, if the current in the Tx coil does not change compared to the current flowing when the Rx coil does not exist (e.g., see Equation 1), This means that there is no Rx coil close to the Tx coil, so a procedure for continuously detecting the Rx coil can be performed.

On the other hand, if there is a change in the current of the Tx coil (e.g., see Equation 2), it may be determined that there is a Rx coil associated with or adjacent to the corresponding Tx coil. In this case, the procedure for determining the position of the Rx coil may be proceeded subsequently.

To determine the position of the Rx coil, in step S830, If more than one Rx coil is present, for each Rx coil, a value that can replace the mutual inductance between the Tx coil and the Rx coil (e.g., [symbol] (Ψ)^{(Rx i)}) based on Equation 4 and Equation 5) may be calculated (S840).

By analyzing the eigenvalues and eigenvectors for the corresponding values, the positions of all Rx coils can be determined.

Based on the determined position of the Rx coil, current may be applied to the Tx coil in step S850.

For example, based on the determined position of the Rx coil, one or more Tx coils to perform power transmission may be determined/identified. Accordingly, the received power for the Rx coil may be controlled (e.g., see Equation 6), and the current for controlling the Tx coil so that the corresponding received power may be transmitted may be determined (e.g., Equation 7).

Through this procedure, the current for optimized power transmission for the Rx coil(s) determined to exist may be controlled to flow in the Tx coil.

Thereafter, in step S860, changes in current in the Tx coil may be continuously detected. This may correspond to a procedure for confirming that the position of the Rx coil changes (in real time).

If the current of the Tx coil changes, this may mean that the Rx coil is added or the position is changed, so it may be configured/controlled to perform the procedure of step S840 again for optimal power transmission.

As described above, the proposed operation of the present disclosure is about a method for determining the position of the Rx coil using only the Tx coil in a wireless power transmission or wireless charging system and controlling the Tx coil to transmit power. The proposed method of the present disclosure relates to a method that may perform power transmission even in an environment where there is no communication between a power transmission device and a power reception device.

Additionally, according to the proposed operation of the present disclosure, a value similar to the mutual inductance between the Tx coil and the Rx coil may be obtained by applying a voltage to the Tx coil and measuring the resulting current without communication between the Tx device and the Rx device. In this regard, the sets of voltages applied to the Tx coils need to be composed of as many independent column vectors as the number of Tx coils.

Additionally, according to the proposed operation of the present disclosure, a value that plays a role similar to mutual inductance may be obtained, and the position of the Rx coil may be determined by analyzing the unique value of the value. At this time, power transmission efficiency may be secured by controlling only the Tx coil with a Rx coil nearby to operate and controlling the remaining Tx coils not to operate. In this regard, since only an optimized number of Tx coils may be controlled, the matrix size for the Tx coil control may be reduced, there is an advantage that the implementation complexity for Tx coil control may be reduced.

Additionally, according to the proposed operation of the present disclosure, when the position of the Rx coil is determined, it is possible to determine which Tx coil exists around the Rx coil by analyzing a value that plays a role similar to mutual inductance. Through this, it is possible to transmit power to the Rx coil by controlling only the Tx coil determined to exist in the vicinity of the Rx coil from a formula using a value that plays a role similar to mutual inductance.

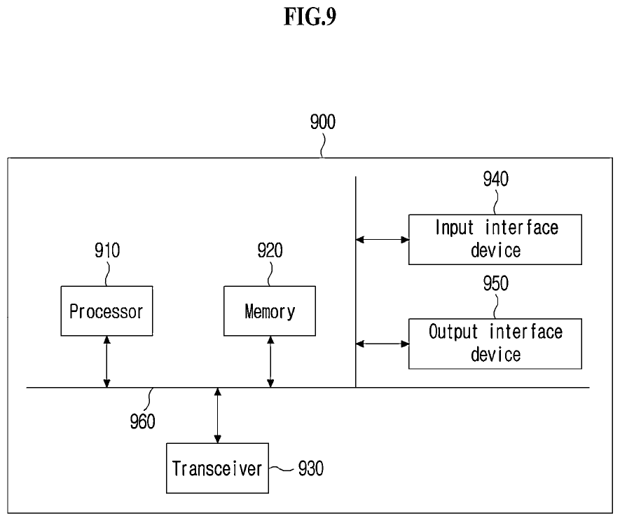

FIG. 9 is a block diagram illustrating an apparatus according to an embodiment of the present disclosure.

Referring to FIG. 9, a device 900 may represent a device in which a method for performing a position estimation for the multiple Rx coil and wireless power transmission described in the present disclosure is implemented.

For example, the device 900 may generally support/perform a function to determine a position of one or more Rx coils and whether to exist, a function to transmit power to the existing Rx coil.

The device 900 may include at least one of a processor 910, a memory 920, a transceiver 930, an input interface device 940, and an output interface device 950. Each of the components may be connected by a common bus 960 to communicate with each other. In addition, each of the components may be connected through a separate interface or a separate bus centering on the processor 910 instead of the common bus 960.

The processor 910 may be implemented in various types such as an application processor (AP), a central processing unit (CPU), a graphic processing unit (GPU), etc., and may be any semiconductor device that executes a command stored in the memory 920. The processor 910 may execute a program command stored in the memory 920. The processor 910 may be configured to implement a method/device for performing a position estimation for the multiple Rx coil and wireless power transmission based on FIGS. 1 to 8 described above.

And/or, the processor 910 may store a program command for implementing at least one function for the corresponding modules in the memory 920 and may control the operation described based on FIGS. 1 to 8 to be performed.

The memory 920 may include various types of volatile or non-volatile storage media. For example, the memory 920 may include read-only memory (ROM) and random access memory (RAM). In an embodiment of the present disclosure, the memory 920 may be located inside or outside the processor 910, and the memory 920 may be connected to the processor 910 through various known means.

The transceiver 930 may perform a function of transmitting and receiving data processed/to be processed by the processor 910 with an external device and/or an external system.

The input interface device 940 is configured to provide data to the processor 910.

The output interface device 950 is configured to output data from the processor 910.

The components described in the example embodiments may be implemented by hardware components including, for example, at least one digital signal processor (DSP), a processor, a controller, an application-specific integrated circuit (ASIC), a programmable logic element, such as an FPGA, GPU other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (UM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, it is intended that this disclosure embrace all other substitutions, modifications and variations belong within the scope of the following claims.

### Statement Regarding Prior Disclosures by the Inventor or a Joint Inventor

The inventors of the present application have made related disclosure in Jun Heo et al., “Position Estimation of Multiple Receiving Coils and Power Transmission Control for WPT without Feedback,” Energies 2022, Nov. 17, 2022, 15, 8621. The related disclosure was made less than one year before the effective filing date (Mar. 7, 2023) of the present application and the inventors of the present application are the same as those of the related disclosure. Accordingly, the related disclosure is disqualified as prior art under 35 USC 102(a) (1) against the present application. See 35 USC 102 (b) (1) (A).

What is claimed is:

1. A method for performing wireless power transmission, the method comprising:
calculating a current value flowing through one or more transmitting (Tx) coils by measuring an impedance value of the one or more Tx coils;
identifying whether a receiving (Rx) coil associated with the one or more Tx coils exists, based on a change in the current value;
when one or more Rx coils exist, calculating a correlation value between a Tx coil and a Rx coil for each of the one or more Rx coils, based on a voltage and a current applied to the one or more Tx coils;
determining a position of the one or more Rx coils, based on the correlation value; and
performing wireless power transmission to the one or more Rx coils, based on the determined position.

2. The method of claim 1,
wherein the correlation value is calculated through a matrix calculated using a voltage vector and a current vector for each of the one or more Tx coils and the impedance value.

3. The method of claim 1,
wherein the position of the one or more Rx coils is determined based on a position of the Tx coil corresponding to a component having a magnitude greater than a pre-defined value in the eigenvector corresponding to the largest eigenvalue of the correlation value.

4. The method of claim 1,
wherein, when a first Rx coil and a second Rx coil exist, the correlation value for the second Rx coil is calculated by subtracting a correlation value calculated for the first Rx coil from a correlation value calculated for both the first Rx coil and the second Rx coil.

5. The method of claim 1,
wherein the change in the current value is determined based on a current value calculated based on a voltage applied to the one or more Tx coils and the impedance value when a Rx coil is absent.

6. The method of claim 1,
wherein a length of the eigenvector corresponding to the largest eigenvalue of the correlation value is equal to the number of the one or more Tx coils.

7. The method of claim 6,
wherein each component of the eigenvector is mapped one-to-one with the one or more Tx coils.

8. The method of claim 7,
wherein the wireless power transmission is performed by a Tx coil corresponding to a component in the eigenvector having a value greater than a pre-defined value.

9. The method of claim 1,
wherein a check for whether a receiving (Rx) coil associated with the one or more Tx coils exists is continuously performed according to a pre-configured period.

10. An apparatus for performing wireless power transmission, the apparatus comprising:
a processor and a memory,
wherein the processor is configured to:
calculate a current value flowing through one or more transmitting (Tx) coils by measuring an impedance value of the one or more Tx coils;
identify whether a receiving (Rx) coil associated with the one or more Tx coils exists, based on a change in the current value;
when one or more Rx coils exist, calculate a correlation value between a Tx coil and a Rx coil for each of the one or more Rx coils, based on a voltage and a current applied to the one or more Tx coils;
determine a position of the one or more Rx coils, based on the correlation value; and
perform wireless power transmission to the one or more Rx coils, based on the determined position.

11. The apparatus of claim 10,
wherein the correlation value is calculated through a matrix calculated using a voltage vector and a current vector for each of the one or more Tx coils and the impedance value.

12. The apparatus of claim 10,
wherein the position of the one or more Rx coils is determined based on a position of the Tx coil corresponding to a component having a magnitude greater than a pre-defined value in the eigenvector corresponding to the largest eigenvalue of the correlation value.

13. The apparatus of claim 10,
wherein, when a first Rx coil and a second Rx coil exist, the correlation value for the second Rx coil is calculated by subtracting a correlation value calculated for the first Rx coil from a correlation value calculated for both the first Rx coil and the second Rx coil.

14. The apparatus of claim 10,
wherein the change in the current value is determined based on a current value calculated based on a voltage applied to the one or more Tx coils and the impedance value when a Rx coil is absent.

15. The apparatus of claim 10,
wherein a length of the eigenvector corresponding to the largest eigenvalue of the correlation value is equal to the number of the one or more Tx coils.

16. The apparatus of claim 15,
wherein each component of the eigenvector is mapped one-to-one with the one or more Tx coils.

17. The apparatus of claim 16,
wherein the wireless power transmission is performed by a Tx coil corresponding to a component in the eigenvector having a value greater than a pre-defined value.

18. The apparatus of claim 10,
wherein a check for whether a receiving (Rx) coil associated with the one or more Tx coils exists is continuously performed according to a pre-configured period.

19. One or more non-transitory computer readable medium storing one or more instructions,
wherein the one or more instructions are executed by one or more processors and control an apparatus for performing wireless power transmission to:
calculate a current value flowing through one or more transmitting (Tx) coils by measuring an impedance value of the one or more Tx coils;
identify whether a receiving (Rx) coil associated with the one or more Tx coils exists, based on a change in the current value;
when one or more Rx coils exist, calculate a correlation value between a Tx coil and a Rx coil for each of the one or more Rx coils, based on a voltage and a current applied to the one or more Tx coils;
determine a position of the one or more Rx coils, based on the correlation value; and
perform wireless power transmission to the one or more Rx coils, based on the determined position.
